(19) United States
(12) Patent Application Publication
(10) Pub. No.: US 2018/0069774 A1
(43) Pub. Date: Mar. 8, 2018

(54) MONITORING AND REPORTING TRANSMISSION AND COMPLETENESS OF DATA UPLOAD FROM A SOURCE LOCATION TO A DESTINATION LOCATION

(71) Applicants: Shiliang LI, Redmond, WA (US); Bei LU, Redmond, WA (US); Shanming XUAN, Redmond, WA (US); Kuntao YU, Redmond, WA (US); Jiajie ZHONG, Redmond, WA (US); Zhigang ZHUANG, Redmond, WA (US); Jay D. AUSTIN, Redmond, WA (US); Hai-Yun HE, Redmond, WA (US); Yunquan PENG, Redmond, WA (US); MICROSOFT TECHNOLOGY LICENSING, LLC, Redmond, WA (US)

(72) Inventors: Shiliang LI, Beijing (CN); Bei LU, Beijing (CN); Shanming XUAN, Beijing (CN); Kuntao YU, Beijing (CN); Jiajie ZHONG, Shenzhen, Guangdong (CN); Zhigang ZHUANG, Beijing (CN); Jay D. AUSTIN, Stockholm (SE); Hai-Yun HE, Beijing (CN); Yunquan PENG, London (GB)

(73) Assignee: MICROSOFT TECHNOLOGY LICENSING, LLC, Redmond, WA (US)

(21) Appl. No.: 15/553,857

(22) PCT Filed: Mar. 2, 2015
(86) PCT No.: PCT/CN2015/073484

§ 371 Date: Aug. 25, 2017

(51) Int. Cl. H04L 12/26; H04L 29/08; G06F 11/07

(52) U.S. Cl. CPC H04L 43/0847; G06F 11/0784; H04L 67/06; H04L 43/50

(57) ABSTRACT

Automated monitoring and reporting of the uploading transmission and the completeness of data uploading from one or more source locations to one or more destination locations is provided. A data uploader module is installed on each computing system or is accessible by each computing system from which user and/or system data may need to be exported to a destination repository. Test data is passed via a data uploader from each source system to one or more designated storage repositories to monitor data upload connectivity, as well as, proper operation of the data uploader module. In addition, data extracted from a source is periodically compared with data received by a destination to analyze and report completeness of data exported from a source system to a destination system. Errors in either transmission or export completeness are reported and corrected as needed.

### BACKGROUND

In modern computing systems, large amounts of data are generated and stored on one or more computers in association with databases, electronic mail systems, web services systems, online software provision systems, document management systems, and the like. In some cases, large data centers house hundreds or even thousands of computers on which are run various software applications and on which are stored data of many types for one or more computing system users. For example, a large data center may be used for processing and storing data of various types for hundreds, thousands or more individual users, companies, educational entities, or any other entity for which data may be processed and stored.

On a periodic basis (at regular and irregular frequencies), data of various types including user data and/or system data must be uploaded from individual computing systems (computers and networks of computers) to one or more designation storage locations at which the data may be analyzed, reported on or otherwise used according to the needs of the recipient. With hundreds or thousands of computing systems (particularly large numbers of computers in a large data center) processing data that must be uploaded to one or more destination storage locations, errors in transmission of the data between source and destination create significant problems. For example, even if data transmission fails or is incomplete from 1% of 50,000 computers operated in a large data center, then data from 500 computers would be considered erroneous. Thus, there is a need for methods and systems for monitoring and reporting the transmission of and completeness of data uploaded from source locations to destination locations. It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

The above and other problems are solved by automated monitoring and reporting of the uploading transmission and the completeness of data uploading from one or more source locations to one or more destination locations. According to aspects of the invention, a data uploader module is installed on each computing system or is accessible by each computing system from which user and/or system data may need to be exported to a destination repository. Upon command, a given data loader module reads, transforms (if required) and exports requested data from a source computing system to a designated destination storage location or repository. In order to ensure such data is properly exported from each source system to each designated storage repository, success of transmission and completeness of data transmission is periodically monitored and reported.

According to aspects of the invention, test data is passed from each source system to one or more designated storage repositories to monitor data upload connectivity, as well as, proper operation of the data uploader module. In addition, data extracted from a source is periodically compared with data received by a destination to analyze and report completeness of data exported from a source system to a destination system. Errors in either transmission or export completeness are reported and corrected as needed.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

The accompanying drawings, which are incorporated in and constitute a part of this disclosure, illustrate various aspects of the present invention.

FIG. 1 is a simplified block diagram of one example of a system architecture for monitoring and reporting of the uploading and uploading completeness of data from a source location to a destination location.

FIG. 2 is a simplified block diagram of one example of a data uploader module for monitoring and reporting of the uploading and uploading completeness of data from a source location to a destination location.

FIG. 3 is a flowchart of an example method for monitoring and reporting of the uploading and uploading completeness of data from a source location to a destination location.

FIG. 4 is a block diagram illustrating example physical components of a computing device with which aspects of the present invention may be practiced.

FIGS. 5A and 5B are simplified block diagrams of a mobile computing device with which aspects of the present invention may be practiced.

FIG. 6 is a simplified block diagram of a distributed computing system in which aspects of the present invention may be practiced.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention, but instead, the proper scope of the invention is defined by the appended claims.

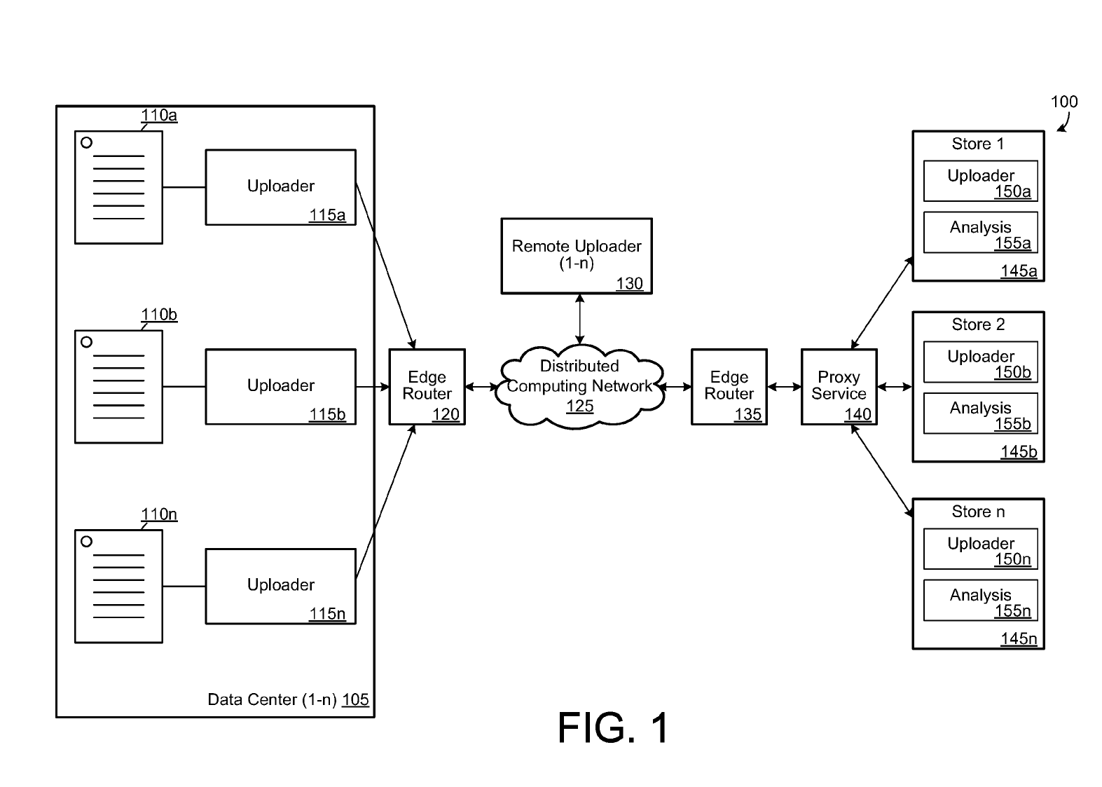

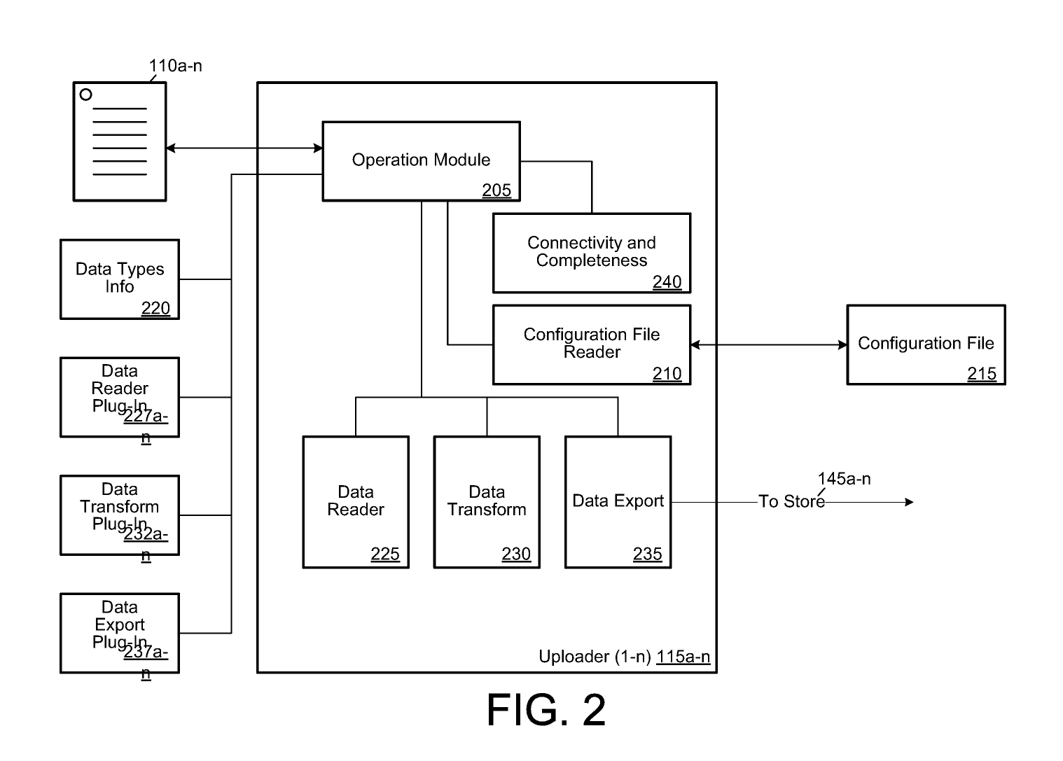

As briefly described above, embodiments of the present invention are directed to automated monitoring and reporting of the uploading transmission and the completeness of data uploading from one or more source locations to one or more destination locations. As described in detail below with reference to FIGS. 1 and 2, an uploader module is installed on or has access to each computer or computing system from which data is to be uploaded to a designated storage repository. For example, user and/or system data generated and/or processed at a source computer or computing system may need to be read from the source system, transformed as required and then exported to a designated storage repository from which the data may be analyzed, reported on or otherwise utilized according to the needs of the recipient at the designated storage location.

According to aspects of the invention, to ensure the quality and completeness of data upload from a source system to a destination system, the uploader module periodically tests its ability to upload data from a source system to a destination system and periodically tests the completeness of data it uploads from a source system to a destination system. For testing the transmission quality of data uploaded from a source system to a destination system, the uploader module periodically transmits test data packets from a given source location to a designated destination location, and any errors in transmission are reported and corrected as needed. In addition, the uploader module generates a completeness log into which information regarding uploaded data is written, and the uploader module periodically compares the completeness log to data actually received at a given destination system for determining whether data uploaded from a source system to a designated storage system is complete. Errors in data upload completeness are reported and corrected as needed.

FIG. 1 is a simplified block diagram of one example of a system architecture for monitoring and reporting of the uploading and uploading completeness of data from a source location to a destination location. The system architecture 100 is comprised of various example computing components for uploading data from a variety of source computing systems (or individual computers) to a variety of destination storage repositories. On the left side of FIG. 1, a data center 105 is illustrative of a data center in which may be housed hundreds, thousands or more individual computers or computing systems 110a, 110b, 110n on which may be stored data of a variety of data types that may be processed using a variety of different computing processes, for example, a variety of software applications. For example, each of the computing devices 110a, 110b, 110n may include computers of various types, for example, server computers, for storing user data in databases, electronic mail systems, document management systems, and the like, and the computing systems 110a, 110b and 110n may be used for running a variety of computing system software applications, for example, database applications, electronic mail systems applications, web services applications, online software provision applications, productivity applications, data management system applications, telecommunications applications, and the like.

As should be appreciated, the data center 105 is also illustrative of one of many data centers that may be co-located, or that may be located at different locations and that may be associated with each other via various transmission systems for passing data between disparate data centers. In addition, while the data center 105 is illustrated as a data center in which numerous computer systems 110a-n may be located for provision of data and services, as described above, the data center 105 is equally illustrative of a single computing device, for example, a desktop, laptop, tablet, handheld, or other computing device operated by an individual user from which user data and/or computer system data may be extracted, transformed (if required) and exported to a destination storage repository for analysis and further use, as desired.

Referring still to the data center 105, each computing device 110a-n is associated with an uploader module 115a, 115b, 115n, respectively, that is operative for uploading user and/or system data from each associated computer/computing system 110a-n and for transforming, if required, and exporting the extracted data to a designated destination storage repository. The uploader module 115a-n is described in further detail below with respect to FIG. 2. According to one aspect of the invention, an uploader module 115a-n may be installed on each associated computer/computing system 110a-n.

Alternatively, a single uploader module 115a may be operated as a standalone module that may be associated with a plurality of computing systems 110a-n. In such a case, the uploader module may operate as a remote uploader module 130 that may access one or more associated computing systems 110a-n through a distributed computing network, for example, the Internet or an intranet. That is, according to aspects of the invention, the uploader module 115a-n may be installed on an associated computing device 110a-n, or the uploader module may operate remotely of a computing device from which data may be extracted for transformation of the data, if required, and for exporting the data to a destination storage repository, as described herein.

Referring still to FIG. 1, an edge router 120 is illustrative of a typical router device for passing extracted data from a given uploader module to systems external to the data center 105. As should be appreciated, the edge router 120 may be responsible for ensuring that data passed from a given data center 105 is properly passed to a desired destination system component, for example, that packetized data passing from the uploader module is properly routed to a correct destination component of the system 100.

The distributed computing network 125 is illustrative of any network such as the Internet or an intranet through which data may be passed from the data center to components external to the data center such as destination storage repositories 145a-n, described below.

The edge router 135 is illustrative or a receiving edge router through which data may be passed to a proxy service 140 responsible for ensuring received data is properly authenticated prior to allowing received data to be passed to one or more destination storage repositories 145a-n.

The storage repositories 145a-n are illustrative of any data storage repository that may be authorized to receive data uploaded via the uploader modules 115a-n. For example, the destination storage repositories 145a-n may be associated with a services provider for storing and analyzing data associated with computing systems and software services provided for customers of the services provider. For example, the storage repository 145a may be designated for receiving user data and computing system data associated with electronic mail services provided by a given services provider. The storage repository 145b may be designated for receiving and analyzing user data and systems data associated with web services of a given services provider. Similarly, the destination storage repository 145n may be associated with online software provision, for example, provision of word processing services, slide presentation application services, database application services, spreadsheet application services, telecommunications application services, and the like provided to various users via one or more online software application services systems.

As should be appreciated, each of the destination storage repositories 145a-n may be associated with different services providers or with different requesters of user and/or computing system data. For example, the repository 145a may be associated with a first telecommunications or software application services provider, the repository 145b may be associated with a second services provider, and so on.

As will be understood by those skilled in the art, providers of computing system services, data management services, online software application services, web services, and the like often need to examine, analyze and otherwise manage computing systems data and user data to ensure that data and computing systems services are operating and being maintained as required. For example, a provider of online software services may need to periodically audit the operating functionalities and capabilities of hundreds or thousands of server computers 110a-n maintained at a large data center 105. Likewise, a provider of online software services may need to monitor user data stored on such data center systems to ensure that user data is being properly processed as required by services agreements between the services provider and various customers. In such a case, operating data and/or used data from a given computer may be extracted by an associated uploader module 115a according to any data type associated with the extracted data and may be passed to and stored at a desired storage repository 145a-n for analysis by a requesting services provider or user.

Before the data is passed to the destination storage repository, the data may require transformation for a variety of reasons. For example, if the data contains sensitive confidential and/or personal information associated with a given user, for example, the user's name, social security number, driver's license number, financial data, and the like, such personally identifiable information (PII) may be scrubbed from the data by the uploader module before the data is passed to the destination storage repository to prevent such personally identifiable information from being passed to an unauthorized person or entity. Similarly, if the data extracted from a given computer of computing system at the data center 105 is stored according to a first format, but the data will be stored at the desired destination storage repository according to a second format, the uploader module 115 may transform the data from the first format to the second format so that it may be properly stored and utilized at the destination storage repository.

Referring still to FIG. 1, according to aspects of the present invention, each destination storage repository 145a-n may be equipped with or associated with uploader modules 150a, 150b, 150n that may be used for extracting, transforming, and storing user data and/or computing system data from computing systems 110a, 110b, 110n at the data center 105 remotely from the data center 105. That is, the uploader modules 150a through 150n may be operated from each requesting destination storage repository 145a, 145b, 145n for requesting, reading, transforming, and storing required user or computing system data. Thus, as described above, the uploader modules 115a, 115b, 115n may be installed on or associated with individual computing systems 110a through 110n, a remote uploader 130 may be used for reading, transforming, and exporting data via a distributing computing network that may be used for accessing desired computing systems 110a through 110n, or the uploader modules 150a, 150b, 150n may access required data remotely from individual destination storage repositories. Alternatively, the uploader modules 150a-n may be used from extracting, transforming and exporting data from the storage repositories 145a-n in the same manner as described for exporting data from the computing systems 110a-n.

The analysis modules 155a, 155b, 155n are illustrative of software applications or other executable modules at the storage repositories 145a-n that may be utilized for analyzing, reporting, and exporting received data, as desired. For example, an analysis module 155a may be operative to analyze documents generated by provided online software services to ensure that such documents were properly saved at respective computing devices 110a-n, as required. An analysis module 155b may be illustrative of a software application or other executable module for analyzing electronic mail traffic for ensuring that electronic mail messages were generated and processed at an associated data center computing device 110a-n according to required electronic mail services processing. That is, any analysis module 155a-n may be utilized at a given destination storage repository for analyzing received data as required by the recipient of the data from the uploader modules 115a-n, 130, 150a-150n.

According to aspects of the invention, data that is stored at analyzed and otherwise utilized at any of the destination storage repositories 145a-145n may be subsequently exported to other destinations, as desired. For example, such data may be analyzed and reported to customers of one or more services providers for reporting periodically on processing performed by the services provider for the requesting customers. In addition, data stored at any of the destination storage repositories 145a-n may be passed back through the system 100 illustrated in FIG. 1 for storage back at the computing devices 110a-n from which the data was originally extracted.

Referring now to FIG. 2, the data uploader 115a-n is illustrated and described. As briefly described above, the uploader 115a-n is a software application or software module containing sufficient computer executable instructions for reading, transforming (if required) and exporting data of a variety of data types from one or many data sources 110a-n to one or many data storage 145a-n. Referring to FIG. 2, the data uploader 115a-n includes an operation module 205 for receiving data upload instructions and for directing the processing of components of the data uploader module 115a-n. A configuration file reader 210 is a module with which the data uploader 115a-n reads a configuration file 215 for data uploading instructions, as described below. A data reader module 225 is operative to read data of a variety of data types via a data reader plug-in module 227a-n. A data transformation module 230 is a module operative for transforming data in response to data transformation information read from the configuration file 215 via a data transformation plug-in 232a-n. A data export module 235 is operative to export data from memory to a designated destination storage repository 145a-n as designated by instructions received from the configuration file 215 via the data export plug-in 237a-n.

That is, the data reader module 225, data transformation module 230, data export module 235 are modules of the data uploader module 115a-n operative to read, transform and export data of a variety of types as designated by information contained in the configuration file 215. And, each of the modules 225, 230, 235 may be enabled to read, transform and export data as instructed based on a variety of plug-ins 227, 232, 237 accessed by the data uploader operation module 205 or installed on the data uploader 115a-n to allow the uploader 115a-n to read, transform and export data according to a variety of data types 220 that are designated for uploading to a given destination storage repository 145a-n.

Various data reader, data transformation and data export plug-in modules 227, 232, 237 may be provided to the data uploaders 115a-n or may be accessed by the data loader modules 115a-n as required for different types of data reading transformation and export. For example, a services provider which needs to receive transformed data from various computing devices operated at a data center 105 may provide data reader plug-ins, data transformation plug-ins, and data export plug-ins for use by data uploader modules 115a-n for reading, transforming and exporting data according to their individual needs.

Data that may be read, transformed, and exported, as described herein, may be of an almost limitless number of different data types. Such data may be in the form of operating systems events, text files, XML files, HTML files, contents of data bases (e.g., SQL databases), electronic mail files, calendaring information, word processing documents, spreadsheet documents, slide presentation documents, tasks documents and files, and the like.

As should be appreciated, a given data uploader 115a-n may be installed on a given computing device 110a-n or may be otherwise associated with or provided access to a given computing device 110a-n, and the data uploader 115a-n may be enabled for reading data of many different types by associating a data reader plug-in 227a-n to allow the uploader 115a-n to read data of a designated type. Similarly, the uploader 115a-n may be enabled to transform data as desired by associating the uploader with a data transformation plug-in required for the desired transformation. Similarly, the uploader module 115a-n may be enabled to export data as desired by associating the uploader with an appropriate data export plug-in 237a-n.

The configuration file 215a is illustrative of a file that may be accessed by the uploader module 115a-n for receiving data uploading instructions for a given set or type of data. Data uploading instructions contained in the configuration file may provide information including the data types associated with data to be uploaded, data reading instructions, as well as, security information for allowing the uploader module to access desired data. In addition, the configuration file may provide instructions on how desired data is to be transformed, if required, and instructions on where uploaded data is to be stored and in what file type exported data is to be stored.

Referring still to FIG. 2, a connectivity and completeness module 240 is illustrative of a software module operated in or associated with the uploader module 115a-n containing sufficient computer executable instructions for monitoring and reporting upload success and completeness of data uploaded from a source computing system 110a-n to a destination storage repository 145a-n, as described above. According to aspects of the invention, the connectivity and completeness module 240 is operated by the uploader module 115a-n at the direction of the operation module 205 to perform connectivity diagnostics for testing the reliability of data transmission between a given source system 110a-n and a designated destination storage repository 145a-n. That is, according to a first diagnostics operation, the connectivity and completeness module 240 tests the operability of a data transmission pipeline between a source system and a designated storage system for ensuring the transmission quality of data passed between the source system and the destination system. A second diagnostic performed by the connectivity and completeness module 240 includes a testing of the completeness of data uploaded from a given source system 110a-n to a designated destination storage repository 145a-n.

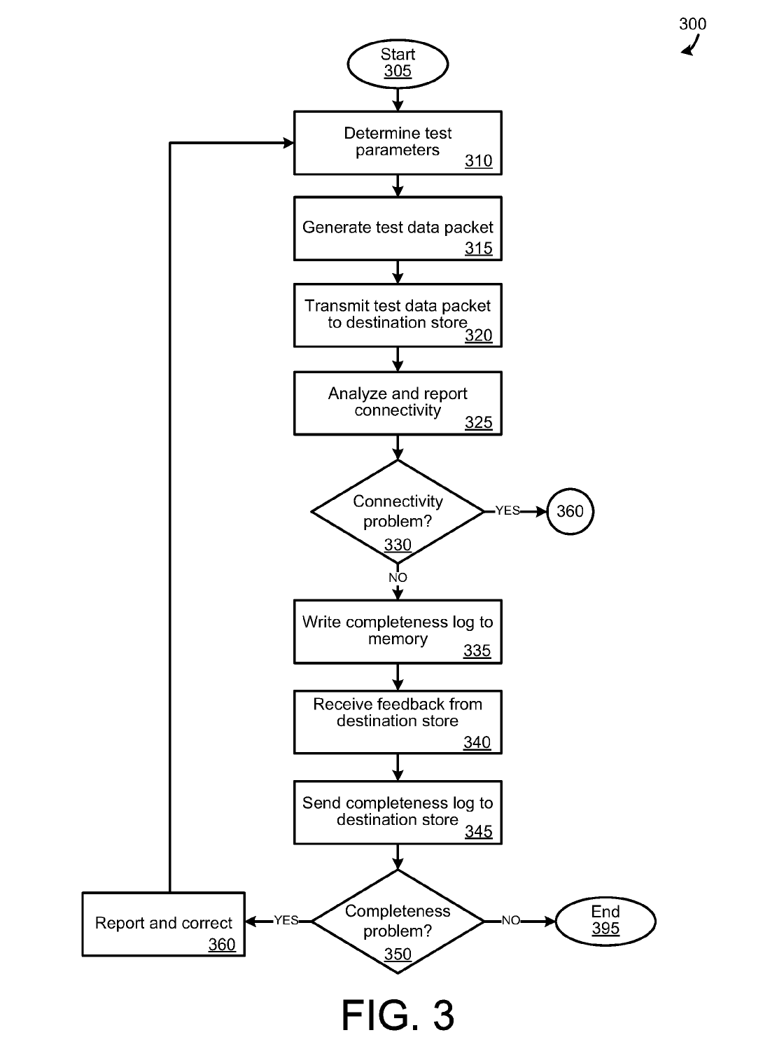

According to the first diagnostic test, the data uploader 115a-n tests whether data may be successfully passed from a source computing device or system 110a-n to a destination storage repository 145a-n. With this first test, an initial question may be answered for a data uploader as to whether the data uploader is in fact installed on a given computing device or system and can access (i.e., communicate with) a designated destination storage repository. As will be described in further detail below with reference to FIG. 3, in order to perform this first diagnostic test, the data uploader periodically generates and sends a data packet from the computing device or system 110a-n onto which it is installed or with which it is associated that looks like a normal data packet that would be extracted from a given computing device or system 110a-n. The test data packet does not require reading or transforming data, as described above, but instead is simply transmitted to a designated destination storage repository 145a-n in accordance with a data export plug-in 237a-n associated with the destination repository for determining whether the data packet may in fact be exported from the source location to the destination location. By sending the test data packet as a “heartbeat” message from the source location to the destination location, transmission data may be generated for allowing an analysis of which, if any, transmission pipelines between a given source device or system and a designated destination system are inoperable due to either a failure of the associated data uploader or a connectivity problem between the source and destination systems.

According to the second diagnostic test, completeness of data uploaded from a source location to a destination location may be monitored, analyzed and reported by generating a log file at the source computer or system 110a-n into which is written information about data that is extracted from the source device or system that may be compared to information received from a designated storage repository for determining whether the data read from the source system matches the data received at the destination system for determining the completeness of the upload.

Having described a system architecture for various aspects of the present invention with respect to FIGS. 1 and 2 above, FIG. 3 is a flowchart of an example method for automated monitoring and reporting of the uploading transmission and the completeness of data uploading from one or more source locations to one or more destination locations. The routine 300 begins at start operation 305 and proceeds to operation 310 where a given uploader module 115a-n, as illustrated in FIG. 2, is instructed to monitor and report data transmission between a designated source computer/system 110a-n to a designated destination storage repository 145a-145n.

At operation 310, the uploader module 115a-n determines the test parameters for monitoring and reporting data transmission and completeness of transmitted data from the designated source to the designated destination. As should be appreciated, the test parameters may include such information as the identity of the source computing device/system onto which the uploader module is installed or to which the uploader module has access, and identity of the destination storage location to which data is to be exported, a type of test to be performed, a frequency of testing to be performed, and the like. For example, the uploader module may be instructed to pass a test data packet identifying the source device/system 110a-n, a length of a test data packet, a date/time stamp associated with transmission of a test data packet, and the like. Alternatively, the uploader module 115a-n may be instructed to pass an actual piece of content, for example, a user data item, or a data item associated with operation of the designated source computer as a content item in the test data packet. In terms of frequency, the uploader module may be instructed to pass the test data packet as an exported data packet to the designated destination storage repository according to any configurable frequency, for example, every five minutes for 24 hours.

As should be appreciated, the foregoing are merely examples of the types of information and frequency of export that may be utilized by the uploader module 115a-n for passing test data packets from a source to a destination for testing transmission success and export completeness. According to one aspect of the invention, the test parameters may be passed to the uploader module via the configuration file 215, or the test parameters may be passed to the uploader file from the designated source device or system. Alternatively, the test parameters may be passed to the uploader module from a given destination device or system for testing the operation of the uploader module in accordance with instructions from a data upload recipient associated with a given destination storage repository 145a-n.

At operation 315, the data uploader module 115a-n generates a test data packet for exporting to a designated destination storage repository 145a-n. According to one aspect of the invention, the test data packet is not generated by reading actual user and/or system data from a source computer/system 110a-n, nor is any transformation of data required of data contained in the test data packet. Alternatively, as should be appreciated, the uploader module 115a-n may be configured to read actual user/system data from the computer/system 110a-n followed by a test or example transformation of the data, as described above with reference to FIGS. 1 and 2, so that the test data packet exported to the designated destination storage repository 145a-n contains a sample of the type of data that may be passed during normal uploader data export. In either case, the test data packet transmission from the data uploader to the designated destination serves as a heartbeat for verifying the operability of transmission connectivity between the uploader and the designated destination location.

According to one aspect, the generated test data packet may include at least information identifying the source computer/system 110a-n associated with the uploader in use for the test, a date/time stamp associated with the test data export, an identification of any data export plug-in utilized for exporting the data and an identification of the intended receiving destination storage repository 145a-n. In addition, a version identifier for the in-use data uploader will be provided in the test data packet for comparing the data uploader version with other data uploader versions in the event transmission connectivity difficulties occur. For example, if a given version of the in-use data uploader is out-of-date such that it is not recognized by a recently updated source computing device/system, information about the version of the currently in-use data uploader 115 may be important for determining the nature of any occurring transmission difficulties.

At operation 320, the data uploader 115a-n transmits the test data packet to the designated destination. As should be appreciated, the test data packet may be sent to the designated destination on a periodic basis, for example, every five minutes for 24 hours, as instructed. In such a case, each test data packet may be identical to other test data packets sent during the testing period except for information that may change during the testing period. For example, a date/time stamp for each test data packet will be different from other test data packets during the testing period, and any changes to the systems being utilized in the test may be reflected in information populated into the test data packet. For example, if test data packets are sent over the course of a 24 hour period, and during the 24 hour period a version change or other change is effected on the source computing device/system or data uploader, such information may be placed in succeeding test data packets passed from the source computer/system to the designated destination storage repository 145a-n.

According to one aspect of the invention, the data uploader may send test data packets from a given source computer/system 110a-n via a number of data export plug-ins 237a-n to one or more designated destination storage locations for testing each data export plug-in for its operability in addition to testing the transmission operability of other components of the system, as described herein.

Referring still to FIG. 3, at operation 325 an analysis may be performed of the exported test data packets for determining the transmission operability of the data uploader, any utilized data export plug-ins and any transmission components between the data uploader and the receiving designated destination storage location. According to one aspect, as each test data packet is received at a designated destination storage repository, a directory file or other file may be populated with information associated with the received data packets in the form of a heartbeat log or other applicable data file for receiving and listing received test data packets. For example, an entry contained in such a file directory or heartbeat log may indicate that a test data packet “XYZ” received from source computer “PQR” running a blank configuration file was received and logged at a given date and time. The example log entry may also include identification information, including version information for the data uploader responsible for sending the test data packet, as well as, identification information for any data export plug-ins utilized in the test data export. If the test data packet includes actual user and/or system data, then the user/system data may be logged in the heartbeat file with other test data packet information.

During the analysis of the received test data packet information contained in the heartbeat log, a comparison of received test data packets from various source computer devices/systems may be compared against a list of known computer devices/systems from which data is to be exported via data uploaders, as illustrated and described above with reference to FIGS. 1 and 2. Thus, if test data packets are sent from each of one or more known computing devices/systems 110a-n to one or more corresponding designated destination storage repository 145a-n, and test data packets are not received and entered into the heartbeat log for any one or more of the known computing device/systems, then a transmission failure may be noted for those computers or computing systems from which a test data packet was not received where a test data packet was attempted.

At operation 330, if it is determined that a connectivity problem exists where one or more test data packets are not received from source computing systems 110a-n, the method 300 proceeds to operation 360 where errors are reported and corrections may be made to one or more components in the system 100, illustrated in FIG. 1, as determined. For example, if test data packets are received from one computing device 110a-n but not from a second computing device 110a-n wherein both computing devices are utilizing the same connectivity system, then a determination may be made that a problem resides with either the data uploader associated with the computer or computing system from which a test data packet is not received, or a problem may exist with an export plug-in utilized for the erroneous test data packet transmission. As should be appreciated, these are only examples of component failures or transmission system failures that may be analyzed based on the lack of receipt of a test data packet, as described above. Various corrective actions may be taken to correct transmission failures, including reinstalling a suspected failing data uploader 115a-n, reinstalling one or more data export plug-ins, checking the edge routers 120, 135, checking authentication problems that may occur at the proxy service 140, and the like.

As mentioned above, in addition to analyzing the test transmissions, reporting of test data packet results may be performed. For example, a report indicating that test data packets show that 90% of installed data uploaders are connecting properly, 8% are installed but are not connecting properly (for example, where heartbeat test messages were received from these data uploaders last week but not currently), and of 2% of the tested data uploaders are not working currently nor have they successfully passed test data packets in the past. Such reported information may be used by administrative personnel for determining data transmission problems and for effecting corrective changes.

In addition, a version report may be generated for the components used in the test data packet transmissions. For example, a version report may show that 85% of tested data uploaders are the current version minus one version update, 5% of the tested data uploaders are the current version minus two version updates, and 5% of the data uploaders are the current version. Thus, such a report may cause administrative personnel to realize that 95% of the currently operating data uploaders are not the current version and may require version upgrading to ensure proper operation.

At operation 335, the connectivity and completeness module 240 of the data uploader module conducts the second diagnostic test for determining completeness of data exported from a designated source computing device/system 110a-n to one or more designated destination storage repository 145a-n. A completeness log is generated at the local computing device/system 110a-n associated with the being-tested data uploader 115a-n. For purposes of completeness testing, a test data packet may be exported to a destination storage location, as described above, or completeness testing may be performed for one or more uploads of actual user and/or system data, as described above with reference to FIGS. 1 and 2.

In either case, as a data packet, whether test or actual, is uploaded, information associated with the data packet may be written to the completeness log and stored in local memory at the computing device/system 110a-n and associated data uploader for subsequent comparison with information received at the designated destination storage repository. For example, a completeness log entry such as “time stamp 10:30 a.m., reading log file A out of directory 123, directory 123 contains five files that are each ten megabytes in size.” After writing information to the completeness log, the associated data packet, whether test or actual, is uploaded to the designated destination storage repository, as described above with reference to FIGS. 1 and 2.

In response, the data uploader receives a call back from the designated destination storage repository providing information about what it has received. For example, the destination storage location may pass a call back to the data uploader saying that it received information equal and corresponding to the information passed by the data uploader and entered into the completeness log by the data uploader. Alternatively, the data uploader may receive a call back from the destination storage repository providing information not matching the information provided for the uploaded data. In either case, the data uploader writes the call back information into the completeness log at operation 340, and at operation 345, the data uploader sends the completeness log to the designated destination storage repository for analysis.

According to aspects of the invention, the completeness log is a log that gets written to the local disc or memory as the uploader is running. When the uploader gets the call back from the destination that acknowledges the uploaded completeness log, the uploader writes another line in the log that records the call back information, for example, “time stamp 10:35 a.m., successfully uploaded 4 megabytes of log type A.” And so, the uploader then, it writes this log to disc and then it uploads its own log to destination like Cosmos. The uploader uploads its own completeness log as its running. The accuracy of completeness log is trusted in conjunction with the heartbeat data. Thus, the heartbeat data confirms that the data transmission pipeline is open and, in addition, the heartbeat data provides reliability of the completeness of transmitted data.

At operation 350, an analysis of the received completion log may be performed at the receiving destination storage repository for determining whether the information extracted from the computing device/system 110a-n matches the data received at the designated destination storage repository for determining whether the data upload was complete. For example, when the completeness data arrives in the destination, analysis jobs may be run on the data that provide a variety of useful information about the uploader's performance and the quality of the data that is being uploaded. That is, completeness logs may be reviewed over time to track various data information such as log type, file size in memory over time, etc. For example, an analysis may show that at a timestamp of 10:00 am, file size was 5 megabytes in memory, at 11:00 am, file size was 10 megabytes, and at 12:00 noon, file size was 15 megabytes, resulting in a trend showing the being tested uploader is able to upload 5 megabytes each hour. If a next completeness log entry shows a file size of only 1 megabyte, then a concern may be surfaced that the uploader in question is no longer passing the expected amount of data. Thus, various uploader performance metrics may be analyzed such as log size over time, the upload size, the upload speed, and the like.

If at operation 350, a determination is made that incomplete data uploads are occurring from a given computing device/system 110a-n via a given data uploader 115a-n, errors may be reported, and corrective action may be accomplished at operation 360, as described above. The routine ends at operation 395.

While the invention has been described in the general context of program modules that execute in conjunction with an application program that runs on an operating system on a computer, those skilled in the art will recognize that the invention may also be implemented in combination with other program modules. Generally, program modules include routines, programs, components, data structures, and other types of structures that perform particular tasks or implement particular abstract data types.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), handheld devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

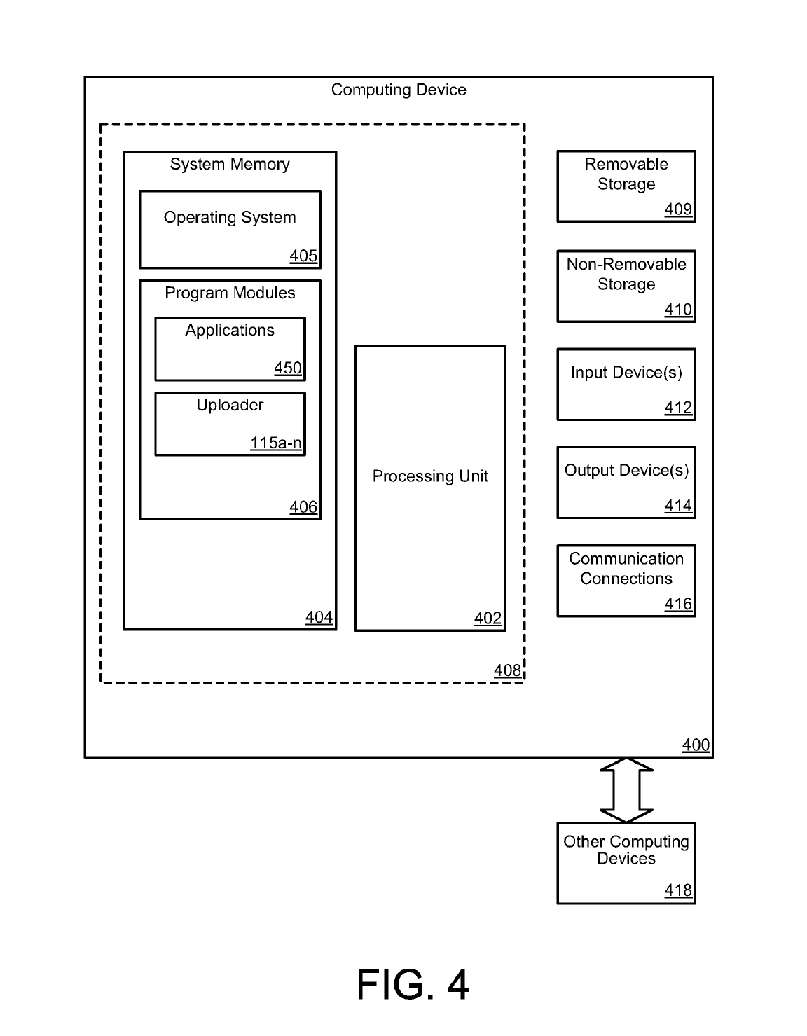

FIGS. 4-6 and the associated descriptions provide a discussion of a variety of operating environments in which embodiments of the invention may be practiced. However, the devices and systems illustrated and discussed with respect to FIGS. 4-6 are for purposes of example and illustration and are not limiting of a vast number of computing device configurations that may be utilized for practicing embodiments of the invention, described herein.

FIG. 4 is a block diagram illustrating physical components (i.e., hardware) of a computing device 400 with which embodiments of the invention may be practiced. The computing device components described below may be suitable for the computing devices 110, 115, 145, described above. In a basic configuration, the computing device 400 may include at least one processing unit 402 and a system memory 404. Depending on the configuration and type of computing device, the system memory 404 may comprise, but is not limited to, volatile storage (e.g., random access memory), non-volatile storage (e.g., read-only memory), flash memory, or any combination of such memories. The system memory 404 may include an operating system 405 and one or more program modules 406 suitable for running software applications 450. The operating system 405, for example, may be suitable for controlling the operation of the computing device 400. Furthermore, embodiments of the invention may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by a removable storage device 409 and a non-removable storage device 410.

As stated above, a number of program modules and data files may be stored in the system memory 404. While executing on the processing unit 402, the program modules 406 may perform processes including, but not limited to, one or more of the stages of the method 300 illustrated in FIG. 3. Other program modules that may be used in accordance with embodiments of the present invention and may include applications such as electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to providing an activity stream across multiple workloads may be operated via application-specific logic integrated with other components of the computing device 400 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 400 may also have one or more input device(s) 412 such as a keyboard, a mouse, a pen, a sound input device, a touch input device, etc. The output device(s) 414 such as a display, speakers, a printer, etc. may also be included. The aforementioned devices are examples and others may be used. The computing device 400 may include one or more communication connections 416 allowing communications with other computing devices 418. Examples of suitable communication connections 416 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 404, the removable storage device 409, and the non-removable storage device 410 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media or transmission media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

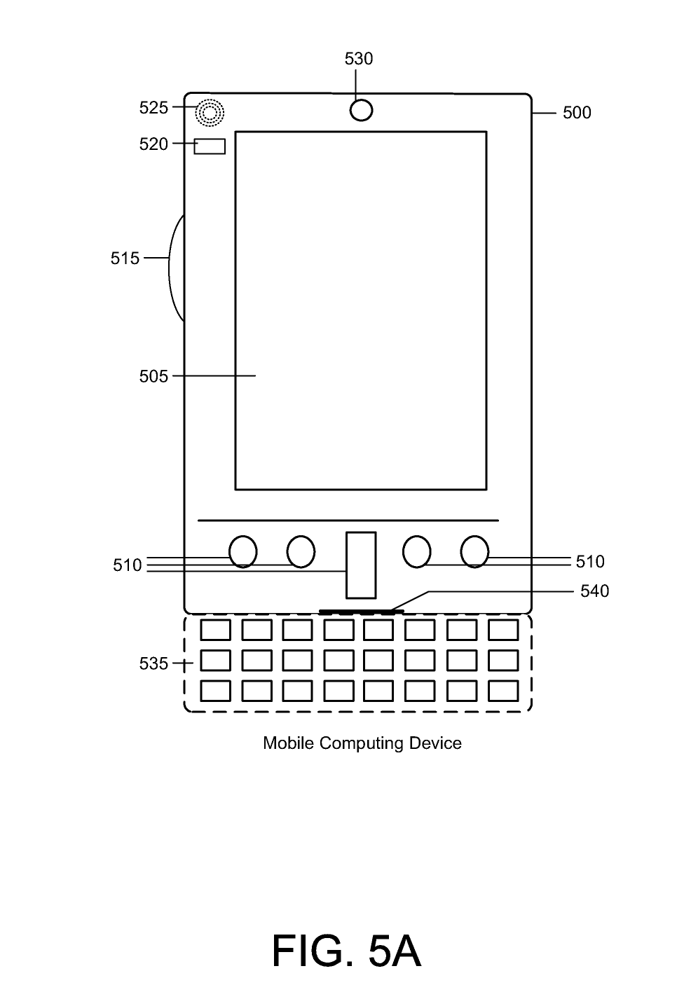

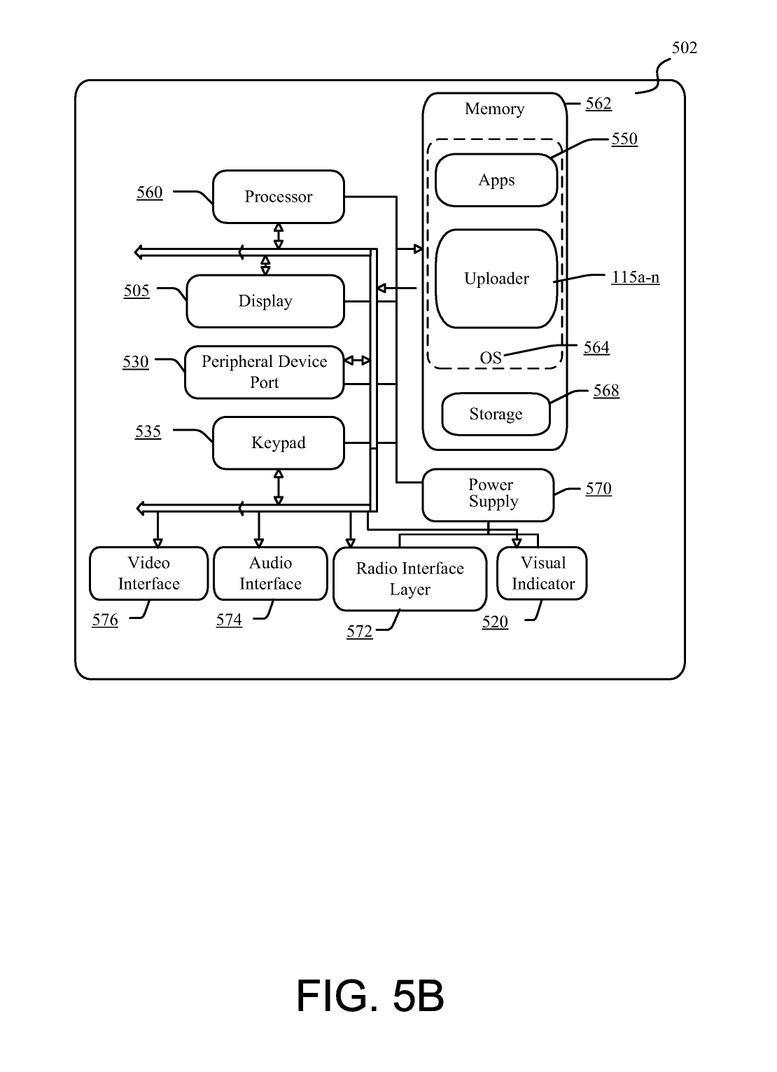

FIGS. 5A and 5B illustrate a mobile computing device 500, for example, a mobile telephone, a smart phone, a tablet personal computer, a laptop computer, and the like, with which embodiments of the invention may be practiced. With reference to FIG. 5A, one embodiment of a mobile computing device 500 for implementing the embodiments is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. The display 505 of the mobile computing device 500 may also function as an input device (e.g., a touch screen display). If included, an optional side input element 515 allows further user input. The side input element 515 may be a rotary switch, a button, or any other type of manual input element. In alternative embodiments, mobile computing device 500 may incorporate more or less input elements. For example, the display 505 may not be a touch screen in some embodiments. In yet another alternative embodiment, the mobile computing device 500 is a portable phone system, such as a cellular phone. The mobile computing device 500 may also include an optional keypad 535. Optional keypad 535 may be a physical keypad or a “soft” keypad generated on the touch screen display. In various embodiments, the output elements include the display 505 for showing a graphical user interface (GUI), a visual indicator 520 (e.g., a light emitting diode), and/or an audio transducer 525 (e.g., a speaker). In some embodiments, the mobile computing device 500 incorporates a vibration transducer for providing the user with tactile feedback. In yet another embodiment, the mobile computing device 500 incorporates peripheral device port 540, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one embodiment of a mobile computing device. That is, the mobile computing device 500 can incorporate a system (i.e., an architecture) 502 to implement some embodiments. In one embodiment, the system 502 is implemented as a “smart phone” capable of running one or more applications (e.g., browser, e-mail, calendaring, contact managers, messaging clients, games, and media clients/players). In some embodiments, the system 502 is integrated as a computing device, such as an integrated personal digital assistant (PDA) and wireless phone.

One or more application programs 550 may be loaded into the memory 562 and run on or in association with the operating system 564. Examples of the application programs include phone dialer programs, electronic communication applications, personal information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 550 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500.

The system 502 has a power supply 570, which may be implemented as one or more batteries. The power supply 570 might further include an external power source, such as an AC adapter or a powered docking cradle that supplements or recharges the batteries.

The system 502 may also include a radio 572 that performs the function of transmitting and receiving radio frequency communications. The radio 572 facilitates wireless connectivity between the system 502 and the “outside world,” via a communications carrier or service provider. Transmissions to and from the radio 572 are conducted under control of the operating system 564. In other words, communications received by the radio 572 may be disseminated to the application programs 550 via the operating system 564, and vice versa.

The visual indicator 520 may be used to provide visual notifications and/or an audio interface 574 may be used for producing audible notifications via the audio transducer 525. In the illustrated embodiment, the visual indicator 520 is a light emitting diode (LED) and the audio transducer 525 is a speaker. These devices may be directly coupled to the power supply 570 so that when activated, they remain on for a duration dictated by the notification mechanism even though the processor 560 and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. In accordance with embodiments of the present invention, the microphone may also serve as an audio sensor to facilitate control of notifications, as will be described below. The system 502 may further include a video interface 576 that enables an operation of an on-board camera 530 to record still images, video stream, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated in FIG. 5B by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio 572 or via a distributed computing network. Similarly, such data/information may be readily transferred between computing devices for storage and use according to well-known data/information transfer and storage means, including electronic mail and collaborative data/information sharing systems.

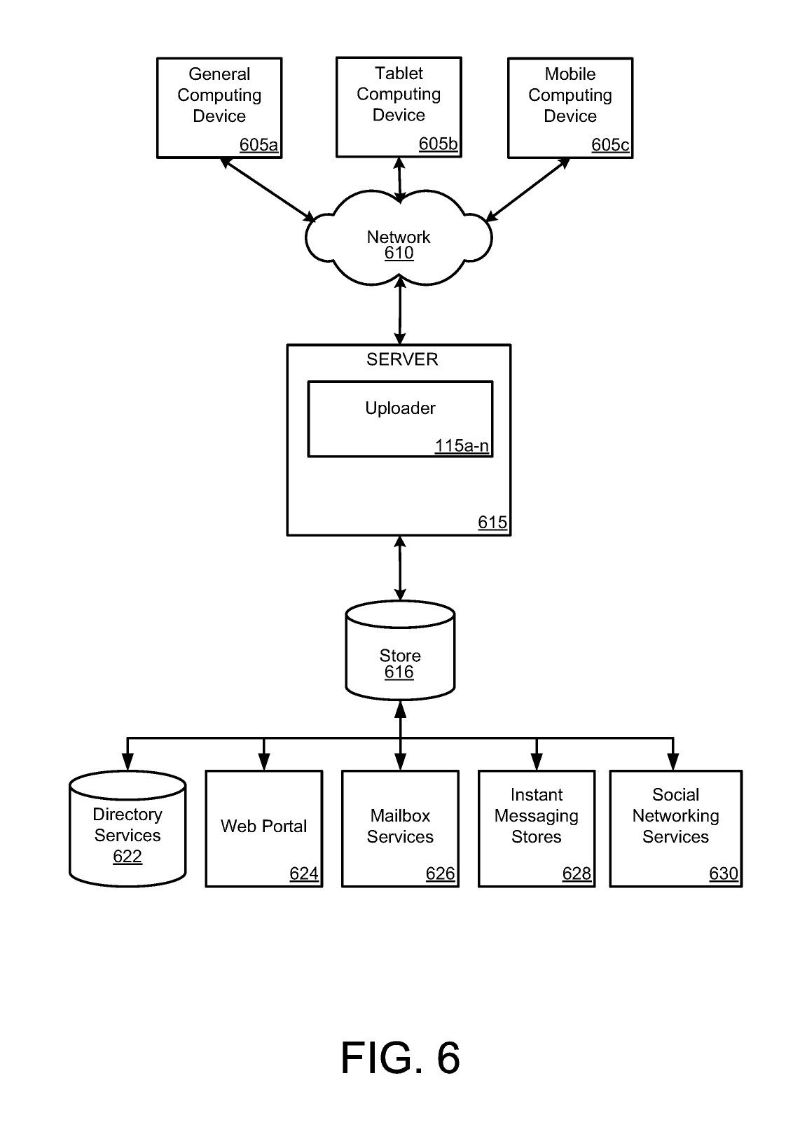

FIG. 6 illustrates one embodiment of the architecture of a system for providing the functionality described herein across components of a distributed computing environment. Content developed, interacted with, or edited in association with the applications described above may be stored in different communication channels or other storage types. For example, various documents may be stored using a directory service 622, a web portal 624, a mailbox service 626, an instant messaging store 628, or a social networking site 630. The application 450 (e.g., an electronic communication application) may use any of these types of systems or the like for providing the functionalities described herein across multiple workloads, as described herein. A server 615 may provide the functionality to clients 605a-c and 110a-n. As one example, the server 615 may be a web server providing the application functionality described herein over the web. The server 615 may provide the application functionality over the web to clients 605a-c and 110a-n through a network 125, 610. By way of example, a computing devices 110a-n may be implemented and embodied in a personal computer 605a, a tablet computing device 605b and/or a mobile computing device 605c (e.g., a smart phone), or other computing device. Any of these embodiments of the client computing device may obtain content from the store 616.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A computer-implemented method of monitoring performance of a data uploading system, comprising:
receiving a request to test data transmission from a source computing system to a destination computing system;
generating a test data packet for transmission from the source computing system to the destination computing system;
transmitting the test data packet from the source computing system to the destination computing system;
receiving the test data packet at the destination computing system; and
analyzing information for the test data packet received at the destination computing system for determining transmission performance of the data uploading system.

2. The computer-implemented method of claim 1, prior to generating a test data packet, determining one or more test parameters for testing data transmission from the source computing system to the destination computing system.

3. The computer-implemented method of claim 2, wherein determining one or more test parameters includes reading a configuration file for one or more test parameters for testing data transmission from the source computing system to the destination computing system.

4. The computer-implemented method of claim 3, wherein determining one or more test parameters includes identifying the source computing system from which the test data packet is to be transmitted.

5. The computer-implemented method of claim 3, wherein determining one or more test parameters includes identifying the destination computing system to which the test data packet is to be transmitted.

6. The computer-implemented method of claim 3, wherein determining one or more test parameters includes determining a frequency of testing to be performed between the source computing system and the destination computing system.

7. The computer-implemented method of claim 3, wherein determining one or more test parameters includes identifying one or more data items for passing with the test data packet.

8. The computer-implemented method of claim 7, wherein identifying one or more data items includes identifying one or more user and/or system data items.

9. The computer-implemented method of claim 1, wherein transmitting the test data packet from the source computing system to the destination computing system includes transmitting the data packet via a data uploader module installed on or associated with the source computing system.

10. The computer-implemented method of claim 9, wherein generating the test data packet includes populating the test data packet with one or more of:
an identification of the source computing system;
an identification of a data uploader module installed on or associated with the source computing system, including a version identification for the data uploader module;
a date/time stamp associated with transmitting the test data packet;
an identification of a data export plug-in module utilized for transmitting the test data packet; and
an identification of a destination computing system to which the test data packet is to be transmitted.

11. The computer-implemented method of claim 1, after receiving the test data packet at the destination computing system, logging information for the received test data packet.

12. The computer-implemented method of claim 1, after analyzing information for the test data packet received at the destination computing system for determining transmission performance of the data uploading system, generating a transmission connectivity report for a transmission pipeline with which the test data packet is transmitted from the source computing system to the destination computing system.

13. The computer-implemented method of claim 1, further comprising:
transmitting data from the source computing system to the destination computing system; and
receiving a responsive communication from the destination computing system, the responsive communication including information about the data transmitted from the source computing system and received at the destination computing system.

14. The computer-implemented method of claim 13, further comprising generating a completeness log at the source computing system for logging information about the data transmitted from the source computing system to the destination computing system.

15. The computer-implemented method of claim 14, in response to receiving a responsive communication from the destination computing system, updating the completeness log at the source computing system with information about the data received at the destination computing system.

16. The computer-implemented method of claim 15, further comprising:
transmitting the updated completion log to the destination computing system;
analyzing the completion log for determining a completeness of the data transmitted from the source computing system to the destination computing system; and
reporting a completeness of the data transmitted from the source computing system to the destination computing system.

17. A system for monitoring performance of a data uploading system, the system comprising:
one or more processors;
memory storing one or more modules that are executable by the one or more processors, the one or more modules comprising:
a data uploader module operative to
receive a request to test data transmission from a source computing system to a destination computing system;
generate a test data packet for transmission from the source computing system to the destination computing system;
transmit the test data packet from the source computing system to the destination computing system;
receive the test data packet at the destination computing system; and
analyze information for the test data packet received at the destination computing system for determining transmission performance of the data uploading system.

18. The system of claim 17, the data uploader module being further operative to
read a configuration file for one or more test parameters for testing data transmission from the source computing system to the destination computing system; and
populate the test data packet with one or more of:
an identification of the source computing system;
an identification of a data uploader module installed on or associated with the source computing system, including a version identification for the data uploader module;
a date/time stamp associated with transmitting the test data packet;
an identification of a data export plug-in module utilized for transmitting the test data packet; and
an identification of a destination computing system to which the test data packet is to be transmitted.

19. The system of claim 17, the data uploader module being further operative to
transmit user and/or system data from the source computing system to the destination computing system;
generate a completeness log at the source computing system for logging information about the data transmitted from the source computing system to the destination computing system;
update the completeness log at the source computing system with information about the data received at the destination computing system in response to receiving a responsive communication from the destination computing system, the responsive communication including information about the data received at the destination computing system;
transmit the updated completion log to the destination computing system;
analyze the completion log for determining a completeness of the data transmitted from the source computing system to the destination computing system; and
report a completeness of the data transmitted from the source computing system to the destination computing system.

20. A computer readable medium containing computer executable instructions which when executed by a computer perform a method of monitoring performance of a data uploading system, comprising:
receiving a request to test data transmission from a source computer to a destination storage repository;
generating a test data packet for transmission from the source computer to the destination storage repository;
transmitting the test data packet from the source computer to the destination storage repository, the transmitted test data packet serving as a heartbeat message between the source computer and the destination storage repository;
receiving the test data packet at the destination storage repository; and
analyzing information for the test data packet received at the destination storage repository for determining transmission performance of the data uploading system.
